(19) United States
(12) Patent Application Publication
(10) Pub. No.: US 2013/0147714 A1
(43) Pub. Date: Jun. 13, 2013

(54) METHOD AND DEVICE FOR TRACKBALL-BASED PRESS POSITIONING

(71) Applicants: Di Xue, Beijing (CN); Xiaoji Zhu, Beijing (CN); Haiyang Qian, Beijing (CN)

(72) Inventors: Di Xue, Beijing (CN); Xiaoji Zhu, Beijing (CN); Haiyang Qian, Beijing (CN)

(73) Assignee: CHINA MOBILE COMMUNICATIONS CORPORATION, Beijing (CN)

(21) Appl. No.: 13/818,565

(22) PCT Filed: Aug. 23, 2011
(86) PCT No.: PCT/CN2011/078754

§ 371 Date: Feb. 22, 2013

(30) Foreign Application Priority Data
Aug. 23, 2010 (CN) 201010261290.7

(51) Int. Cl. G06F 3/0354

(52) U.S. Cl. CPC G06F 3/03549
USPC 345/167

(57) ABSTRACT

In a method and device for trackball-based press positioning, when the trackball is under pressure, the multi-legged support that supports the trackball will be deformed, and then transmits the deformation information to the processing module. The processing module compares the deformation information with the deformation threshold information stored therein. When it is determined that the trackball is under pressure but not in contact with the pressure sensing module, the trajectory of the trackball is recorded by the positioning module, and corresponding operations are performed on the displayed information in accordance with the trajectory. The press positioning information of the trackball may be recognized, and corresponding operations may be determined in accordance with the information.

The present application claims a priority of the Chinese patent application No. 201010261290.7 entitled “method and device for trackball-based press positioning” and filed on Aug. 23, 2010, which is incorporated herein by reference.

### TECHNICAL FIELD

The present invention relates to the field of smart terminals, in particular to method and device for trackball-based press positioning.

### BACKGROUND

There exists a trackball in a current mobile terminal. A user can perform operation on the trackball, the mobile terminal receives and recognizes the operation, and then positions or selects the information displayed thereon in accordance with the recognition result.

FIG. 1 is a schematic view showing the position of a trackball in a current mobile terminal, where the trackball is connected to a positioning module. When the mobile terminal recognizes that the trackball is being scrolled, it notifies the positioning module to record the trajectory of the trackball. A processing module of the mobile terminal recognizes the trajectory as a positioning operation on the information displayed on a screen. When a pressure sensing module of the mobile terminal senses a pressing operation of the trackball, it transmits the pressing operation to the processing module which recognizes the pressing operation as a point-and-click operation on the information displayed on the screen.

The operations on the trackball that may be recognized by the current mobile terminal merely include a scrolling operation and a pressing operation. The scrolling operation is used to effect a positioning operation on the information displayed on a screen of the mobile terminal, and the pressing operation is used to effect a point-and-click operation on the information displayed on the screen. When the trackball is being pressed and scrolled, it is in contact with the pressure sensing module under the effect of pressure. Due to the friction between the trackball and the pressure sensing module, it is impossible to scroll the trackball under the friction. In addition, when the trackball is being pressed and scrolled, the mobile terminal can merely recognize such operation as a pressing operation or a scrolling operation on the trackball. As a result, the recognition result at the mobile terminal is inaccurate, and the final operation on the information displayed on the screen will not be performed properly.

### SUMMARY

The present invention aims to provide method and device for trackball-based press positioning, so as to effect a press-positioning opreation on a trackball.

The present invention provides a method for trackball-based press positioning, comprising:
receiving, by a processing module, deformation information from a multi-legged support for supporting a trackball and sensing pressure on the trackball;
comparing the received deformation information with deformation threshold information stored therein to determine a type of a pressing opreation on the trackball; and
when it is determined that the trackball is under pressure but not in contact with a pressure sensing module, recording a trajectory of the trackball by a positioning module, and performing corresponding opreations on displayed information in accordance with the trajectory.

The present invention further provides a device for trackball-based press positioning, comprising: a multi-legged support, a trackball, a processing module and a positioning module, wherein,
the multi-legged support, configured to support the trackball and sense pressure on the trackball of a mobile terminal, and transmit its own deformation information under the pressure to the processing module;
the trackball, configured to receive the pressure;
the processing module, configured to receive the deformation information from the multi-legged support, compare the received deformation information with deformation threshold information stored therein, determine a type of a pressing operation on the trackball, and notify the positioning module to determine the opreation information when it is determined that the trackball is under pressure but not in contact with a pressure sensing module; and the positioning module, configured to record a trajectory of the trackball and perform corresponding opreations on the displayed information in accordance with the trajectory.

According to the method and device for trackball-based press positioning, when the trackball is under pressure, the multi-legged support that supports the trackball will be deformed, and then transmits the deformation information to the processing module. The processing module compares the deformation information with the deformation threshold information stored therein. When it is determined that the trackball is under pressure but not in contact with the pressure sensing module, the trajectory of the trackball is recorded by the positioning module, and corresponding operations are performed on the displayed information in accordance with the trajectory. The press positioning information of the trackball may be recognized according to the present invention, and corresponding operations may be determined in accordance with the information. As a result, the accuracy of the recognition result at the mobile terminal and the accuracy of the final operation on the information displayed on a screen will be increased.

### BRIEF DESCRIPTION OF THE DRAWINGS

FIG. 1 is a structural schematic view showing the position of a trackball in a mobile terminal according to the prior art;

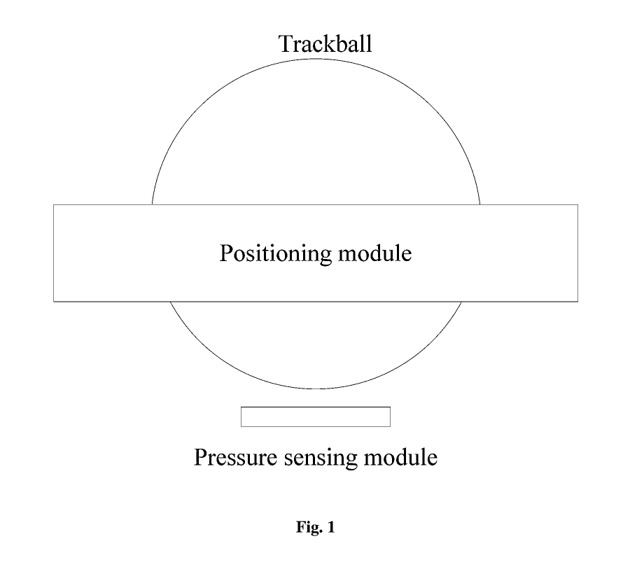

FIG. 2 is a flow chart showing the trackball-based press positioning process according to embodiments of the present invention;

FIG. 3 is a structural schematic view showing a multi-legged support, a pressure sensing module, a trackball and a positioning module according to one embodiment of the present invention;

FIG. 4 is a schematic view showing the elastic deformation of an elastic support of the multi-legged support according to embodiments of the present invention;

FIG. 5 is a flow chart showing the trackball-based press positioning process according to embodiments of the present invention;

FIG. 6 is another flow chart showing the trackball-based press positioning process according to embodiments of the present invention;

FIG. 7 is another flow chart showing the trackball-based press positioning process according to embodiments of the present invention; and

FIG. 8 is a structural schematic view showing a device for trackball-based press positioning according to embodiments of the present invention.

### DETAILED DESCRIPTION

In order to recognize a press positioning operation on a trackball effectively, the present invention provides a method for trackball-based press positioning. According to the method, when the trackball is under pressure, a multi-legged support that supports the trackball is deformed, and then transmits the deformation information to a processing module. The processing module compares the deformation information with deformation threshold information stored therein.

When it is determined that the trackball is under pressure but not in contact with a pressure sensing module, a trajectory of the trackball is recorded by a positioning module, and corresponding operations are performed on the displayed information in accordance with the trajectory. The press positioning information of the trackball may be recognized according to the present invention, and corresponding operations may be determined in accordance with the information. As a result, the accuracy of the recognition result at the mobile terminal and the accuracy of the final operation on the information displayed on a screen will be increased.

The present invention is described hereinafter in conjunction with the drawings.

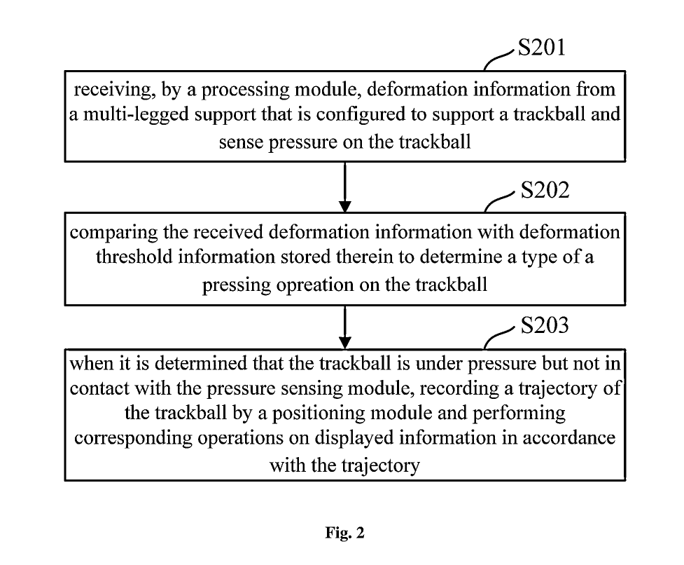

FIG. 2 is a flow chart showing the trackball-based press positioning process according to embodiments of the present invention. The process comprises the following steps.

S201: receiving, by a processing module, deformation information from a multi-legged support that is configured to support a trackball and sense pressure on the trackball.

Each leg of the multi-legged support includes an elastic support and a supporting ball that is in contact with the trackball and connected to the elastic support. The elastic support includes two elastic components connected via a shaft. One of the elastic components is connected to the supporting ball and the other is connected to a fixing module of the multi-legged suppiort in a mobile terminal. The fixing module may be, for example, a circuit board of the mobile terminal, or other hardware modules for fixing the multi-legged support. A sensor provided on the other elastic component for sensing the deformation information may be mounted on the elastic component and/or the shaft.

Step 202: comparing the received deformation information with deformation threshold information stored therein to determine a type of a pressing opreation on the trackball.

When the trackball in the mobile terminal is under no pressure, the distance between the trackball and the pressure sensing module is determined and the deformation information of the multi-legged support that supports the trackball is determined. When the trackball is under pressure and moves downward, if the trackball moves above the presusre sensing module but not in contact therewith, the deformation information of the multi-legged support may also be determined. As a result, it is able to determine a type of a pressing opreation on the trackball in accordane with the deformation information of the multi-legged support.

S203: when it is determined that the trackball is under pressure but not in contact with the pressure sensing module, recording a trajectory of the trackball by a positioning module and performing corresponding operations on the displayed information in accordance with the trajectory.

According to embodiments of the present invention, when the processing module of the mobile terminal recognizes that the trackball is under pressure but not in contact with the pressure sensing module, it may recognize the type of the pressing opreation as “light pressing opreation”. So even if the trackball is pressed, it is also able to perform a scrolling opreation on the trackball. In order to accurately recognize the scrolling operation after the pressing operation, the processing module notifies the positioning module to record the trajectory of the trackball, and then determines the positioning operation on the information displayed on a screen in accordance with the trajectory of the trackball recorded in the positioning module.

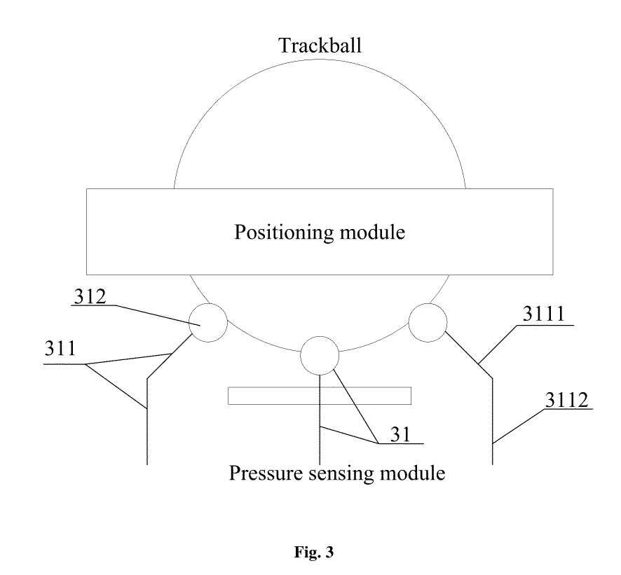

FIG. 3 is a structural schematic view showing a multi-legged support, e.g., a three-legged support, a pressure sensing module, a trackball and a positioning module according to one embodiment of the present invention. In FIG. 3, the three-legged support 31 supports the trackball and senses pressure on the trackball. Each leg of the three-legged support 31 includes an elastic support 311 and a supporting ball 312, and the elastic support 311 is fixed onto a circuit board of the mobile terminal and between the circuit board and the supporting ball 312. The elastic support 311 includes a first elastic component 3111 and a second elastic component 3112 connected to each other via a shaft. To be specific, the first elastic component 3111 is connected to the shaft and the supporting ball 312, and the second elastic component 3112 is connected to the shaft and fixed onto the circuit board.

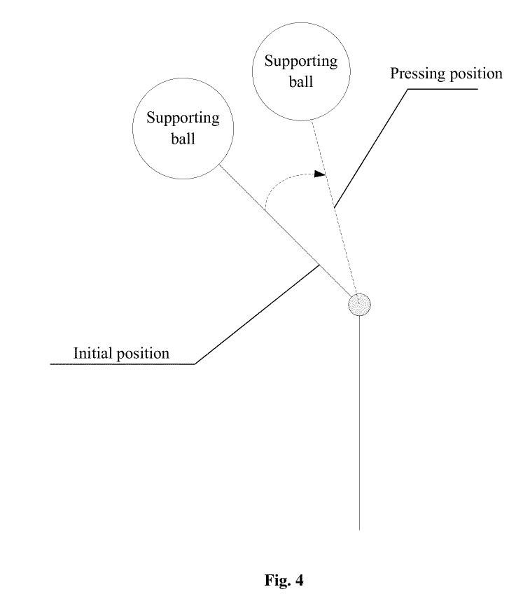

FIG. 4 is a shematic view showing the elastic deformation of an elastic support of the multi-legged support according to embodiments of the present invention. In FIG. 4, initial position represents the deformation of the elastic support when it is not under pressure, and pressing position represents the deformation of the elastic support when it is under pressure. As shown in FIG. 4, the deformation information when the elastic support is under pressure may be determined in accordance with the deformation when the elastic support is under pressure and the deformation when the elastic support is not under pressure. The deformation information may specifically comprise angle change information when the elastic support is under pressure. A sensor may be provided on the shaft that connects the two elastic supports of the multi-legged support. The sensor may be a displacement sensor which senses the displacement in accordance with the laser range finding principle, so as to determine the deformation information of the multi-legged support.

In addition, the multi-legged support includes several elastic supports, each of which is provided with a sensor for sensing the elastic deformation, and the sensor on each elastic support reports the sensed deformation information to the processing module, so the deformation information reported by the elastic supports and received by the processing module may be different from each other. In order to facilitate the calculation and increase the measurement accuracy, the deformation information reported by the elastic supports may be averaged, and an average value of the deformation information reported by the elastic supports may be regarded as the deformation information reported by the multi-legged support. Alternatively, when determining the deformation information reported by the multi-legged support, a sum of the deformation information reported by the elastic supports may also be regarded as the deformation information of the multi-legged support. The method for determining the deformation information may be determined flexibly in accordance with the practical need, as long as the deformation threshold information corresponding to the deformation information of the multi-legged support is stored in the processing module.

The deformation threshold information is stored in the processing module, and the deformation threshold information may include first deformation threshold information which is determined in accordance with the dsitance between the trackball and the pressure sensing module and the deformation information of the multi-legged support that supports the trackball when the trackball is under pressure but not in contact with the pressure sensing module.

When determining the first deformation threshold information, the distance D1 between the trackball and the pressure sensing module when the trackball is not under pressure is known. When the trackball is under pressure, it moves downward for a distance D2 from the pressure sensing module, and such a distance may ensure that the trackball is not in contact with the pressur sensing module, e.g., 1 mm or 0.5 mm. After these two distances are obtained, a distance D for which the trackball moves downward under the pressure may be determined when the trackball is under pressure but not in contact with the pressure sensing module. The distance D is a difference between D1 and D2.

When the trackball moves downward for the distance D, the deformation information of the multi-legged support may be determined in accordance with the distance D and the deformation information of the multi-legged support that supports the trackball when the trackball is under pressure. Therefore, the deformation information of the multi-legged support when the trackball moves downward for the distance D may be regarded as the first deformation threshold information, and this first deformation threshold information is stored locally for the subsequent judgment on the type of the pressing operation on the trackball.

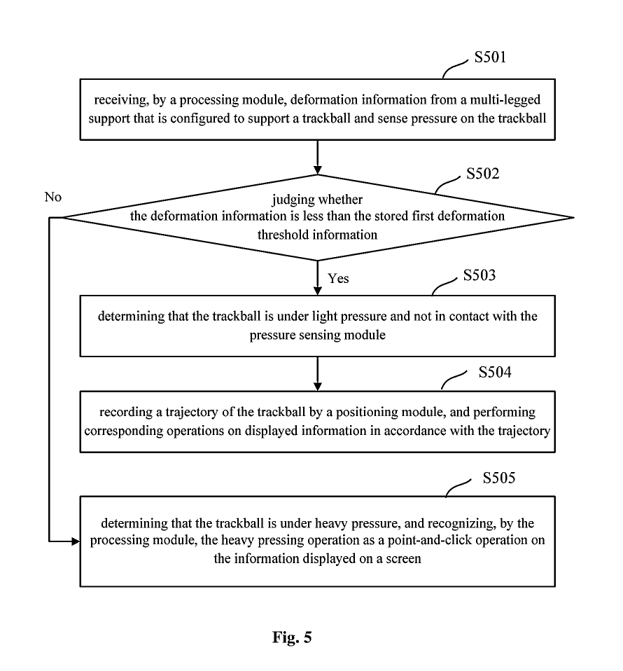

FIG. 5 is a flow chart showing the trackball-based press positioning process according to embodiments of the present invention. The process comprises the following steps.

S501: receiving, by a processing module, deformation information from a multi-legged support that is configured to support a trackball and sense pressure on the trackball.

S502: comparing the received deformation information with first deformation threshold information stored therein, judging whether the deformation information is less than the stored first deformation threshold information, if yes, turning to S503, and otherwise turning to S505.

The first deformation threshold information is determined in accordance with the distance between the trackball and the pressure sensing module, and the deformation information of the multi-legged support that supports the trackball when the trackball is under pressure but not in contact with the pressure sensing module.

S503: determining that the trackball is under light pressure and not in contact with the pressure sensing module.

S504: recording a trajectory of the trackball by a positioning module, and performing corresponding operations on the displayed information in accordance with the trajectory.

S505: determining that the trackball is under heavy pressure, and recognizing, by the processing module, the heavy pressing operation as a point-and-click operation on the information displayed on a screen.

According to the above embodiment, the processing module may determine whether the pressure on the trackball is light pressure or heavy pressure in accordance with the deformation information of the multi-legged support and the first deformation threshold information, and perform corresponding operations in accordance with the type of the pressing operation.

The first deformation threshold information is determined in accordance with the distance D2 for which the trackball moves toward the pressure sensing module, and such a distance D2 may be set flexibly in accordance with the practical need. When the distance D2 is smaller, i.e., when the trackball is closer to the pressure sensing module, a first deformation threshold included in the first deformation threshold information determined in accordance with the distance D2 may be bigger. Usually, it may be judged that the trackball is under light pressure when the deformation information of the multi-legged support is smaller than the first deformation threshold, otherwise the trackball is under heavy pressure. Because the first deformation threshold is determined in accordance with the distance D2, when the deformation information of the multi-legged support is equal to the first deformation threshold, the deformation thereof is actually insufficient to enable the trackball to be in contact with the pressure sensing module. In order to ensure the accuracy when the processing module recognizes the type of the pressing operation and increase the accuracy of information indication, the type of the pressing operation may be determined in accordance with the deformation threshold information and whether the pressure sensing module has received a signal indicating that it is pressed by the trackball.

In addition, when the distance D2 is bigger, i.e., when the trackball is farther away from the pressure sensing module, the first deformation threshold included in the first deformation information determined in accordance with the distance D2 may be smaller. When the type of operation is judged in accordance with the first deformation threshold information and the deformation information of the multi-legged support, the pressing operation may be recognized as heavy pressure when the deformation information of the multi-legged support is greater than the stored first deformation threshold information, and actually at this time the trackball is not in contact with the pressure sensing module. In order to ensure the accuracy when the processing module recognizes the type of the pressing operation and increase the accuracy of operation on the information, the type of the pressing operation may be determined in accordance with the deformation threshold information and whether the pressure sensing module has received a signal indicating that it is pressed by the trackball.

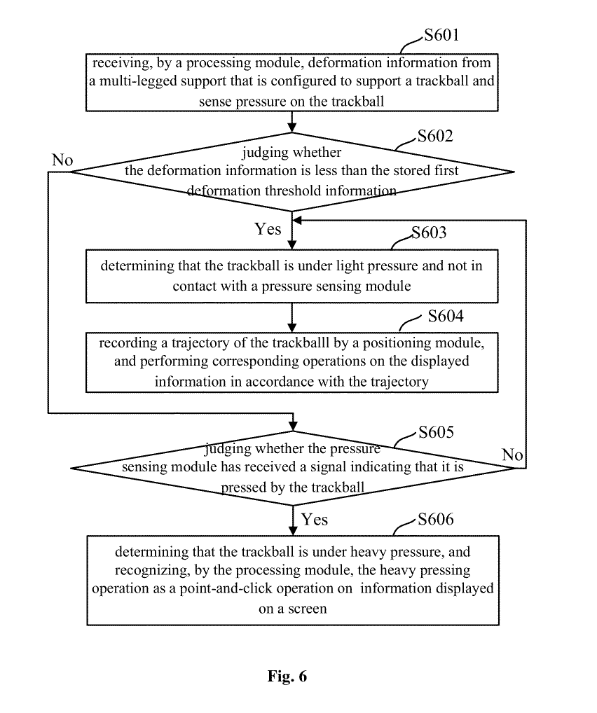

FIG. 6 is another flow chart showing the trackball-based press positioning process according to embodiments of the present invention. The process comprises the following steps:

S601: receiving, by a processing module, deformation information from a multi-legged support that is configured to support a trackball and sense pressure on the trackball;

S602: comparing the received deformation information with first deformation threshold information stored therein, judging whether the deformation information is less than the stored first deformation threshold information, if yes, turning to S603 and otherwise turning to S605;

S603: determining that the trackball is under light pressure and not in contact with a pressure sensing module;

S604: recording a trajectory of the trackballl by a positioning module, and performing corresponding operations on the displayed information in accordance with the trajectory;

S605: judging whether the pressure sensing module has received a signal indicating that it is pressed by the trackball, if yes, turning to S606 and otherwise turning to S603; and

S606: determining that the trackball is under heavy pressure, and recognizing, by the processing module, the heavy pressing operation as a point-and-click operation on the information displayed on a screen.

According to the embodiment of the present invention, the type of the pressing operation is judged in accordance with the deformation information of the multi-legged support and whether the pressure sensing module has received a signal indicating that it is pressed by the trackball. As a result, it is able to further ensure the accuracy when the processing module recognizes the type of the pressing opreation and increase the accuracy of information indication.

In addition, the multi-legged support is configured to support the trackball and sense the pressure on the trackball, and it is deformed when the trackball is under pressure. The deformation information is determined upon the size of the pressure on the trackball. When the trackball is being scrolled, certain pressure may also be applied onto the tarckball. In order to enable the processing module to judge whether the opreation on the trackball is a light pressing operation or a scrolling operation, second deformation threshold information may also be stored in the processing module in the embodiment of the present invention. The second deformation threshold information may be determined in accordance with the deformation information of the multi-legged support generated due to the pressure on the trackball when the trackball is being scrolled.

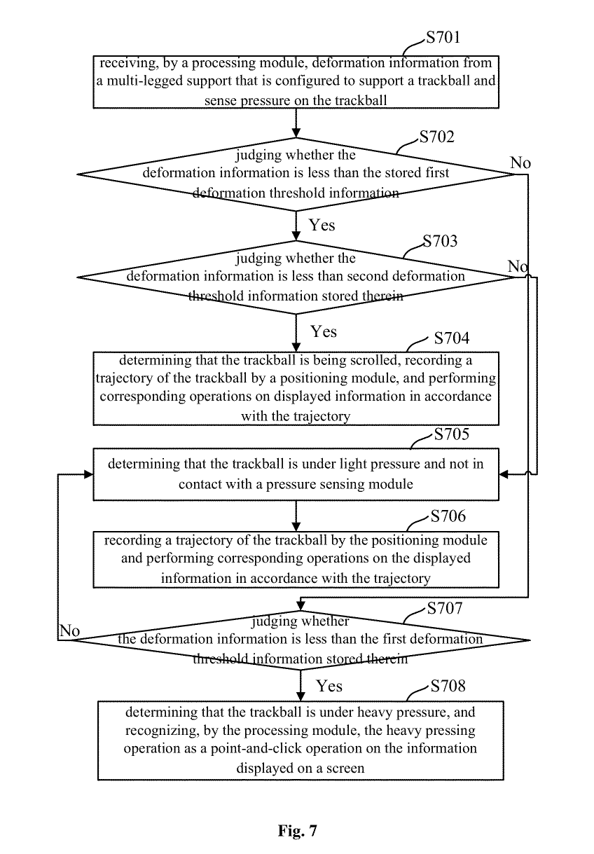

FIG. 7 is another flow chart showing the trackball-based press positioning process according to embodiments of the present invention. The process comprises the following steps:

S701: receiving, by a processing module, deformation information from a multi-legged support that is configured to support a trackball and sense pressure on the trackball;

S702: comparing the received deformation information with first deformation threshold information stored therein, judging whether the deformation information is less than the stored first deformation threshold information, if yes, turning to S703 and otherwise turning to S707;

S703: judging whether the deformation information is less than second deformation threshold information stored therein, if yes, turning to S704 and otherwise turning to S705;

S704: determining that the trackball is being scrolled, recording a trajectory of the trackball by a positioning module, and performing corresponding operations on the displayed information in accordance with the trajectory;

S705: determining that the trackball is under light pressure and not in contact with a pressure sensing module;

S706: recording a trajectory of the trackball by the positioning module and performing corresponding operations on the displayed information in accordance with the trajectory;

S707: judging whether the pressure sensing module has received a signal indicating that it is pressed by the trackball, if yes, turning to S708 and otheriwse turning to S705; and

S708: determining that the trackball is under heavy pressure, and recognizing, by the processing module, the heavy pressing operation as a point-and-click operation on the information displayed on a screen.

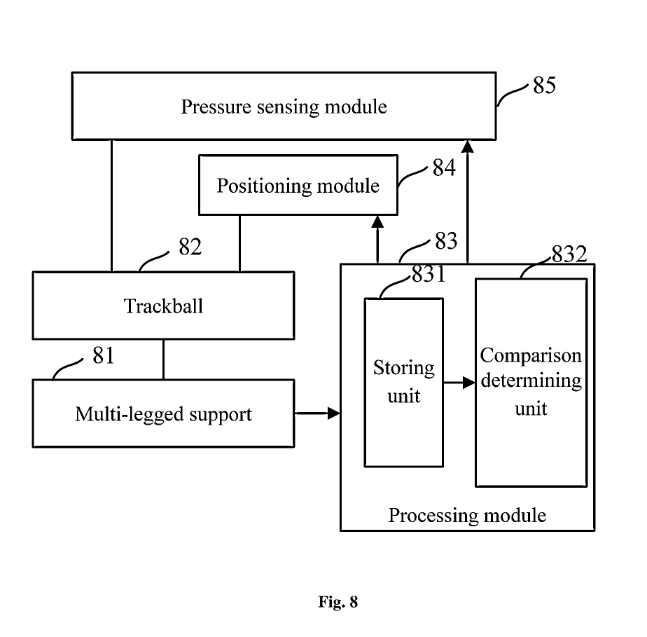

FIG. 8 is a structural schematic view showing a device for trackball-based press positioning according to embodiments of the present invention, the device comprising:
a multi-legged support 81, configured to support a trackball and sense pressure on the trackball of a mobile terminal, and transmit its own deformation information under the pressure to a processing module;
a trackball 82, configured to receive the pressure;
a processing module 83, configured to receive the deformation information from the multi-legged support, compare the received deformation information with deformation threshold information stored therein, determine a type of pressing operation on the trackball, and notify a positioning module to determine the operational information when it is determined that the trackball is under pressure but not in contact with a pressure sensing module; and
a positioning module 84, configured to record a trajectory of the trackball and perform corresponding operations on the displayed information in accordance with the trajectory.

The processing module 83 includes:
a storing unit 831, configured to store first deformation threshold information, which is determined in accordance with a distance between the trackball and the pressure sensing module when the trackball is under pressure but not in contact with the pressure sensing module, and the deformation information of the multi-legged support that supports the trackball when the trackball is under pressure but not in contact with the pressure sensing module; and
a comparison determining unit 832 configured to determine that the trackball is under pressure but not in contact with the pressure sensing module when the deformation information is less than the first deformation threshold information.

The processing module 83 is further configured to judge whether the pressure sensing module has received a signal indicating that it is pressed by the trackball when the deformation information is greater than the first deformation threshold information, and determine that the trackball is under pressure but not in contact with the pressure sensing module when it does not receive the signal indicating that it is pressed by the trackball.

The device further comprises a pressure sensing moduel 85 configured to sense whether pressure is received from the trackball, generate a pressing signal when the pressure from the trackball is sensed, and transmit the pressing signal to the processing module.

The processing module 83 is further configured to perform a point-and-click operation on the displayed information in accordance with the pressing signal when the pressure sensing module receives the pressing signal from the trackball.

The processing module 83 is further configured to compare the deformation information with second deformation threshold information stored therein when the deformation information is less than the first deformation threshold information, determine that the trackball is being scrolled when the deformation information is less than the second deformation threshold information, record the trajectory of the trackball by the positioning module, and perform a positioning operation on the displayed information in accordance with the trajectory.

The multi-legged support 81 includes elastic supports and supporting balls, and each of the elastic supports is provided with a sensor.

The multi-legged support 81 comprises a three-legged support.

The processing module in the embodiments of the present invention may be a Central Processing Unit (CPU), the positioning module may be a sensing element, e.g., a sensor that can recognize scrolling of a trackball, and the pressure sensing module may be a sensing element, e.g., a sensor that can be used for sensing.

According to the method and device for trackball-based press positioning, when the trackball is under pressure, the multi-legged support supporting the trackball will be deformed, and then the multi-legged support transmits the deformation information to the processing module. The processing module compares the deformation information with the deformation threshold information stored therein. When it is determined that the trackball is under pressure but not in contact with the pressure sensing module, the trajectory of the trackball is recorded by the positioning module, and corresponding operations are performed on the displayed information in accordance with the trajectory. The press positioning information of the trackball may be recognized according to the present invention, and corresponding operations may be determined in accordance with the information. As a result, the accuracy of the recognition result at the mobile terminal and the accuracy of the final operation on the information displayed on a screen will be increased.

The above are merely the preferred embodiments of the present invention, but are not used to limit the present invention. Any modification, substitution or improvement, if without departing from the spirit and principle of the present invention, shall be included the scope of the present invention.

It should be appreciated that, the present invention may be provided as a method, a system or a computer program product, so the present invention may be in the form of full hardware embodiments, full software embodiments, or combinations thereof. In addition, the present invention may be in the form of a computer program product implemented on one or more computer-readable storage mediums (including but not limited to disk memory, CD-ROM and optical memory) having computer-readable program codes.

The present invention is described with reference to the flow charts and/or block diagrams showing the method, device (system) and computer program product according to the embodiments of the present invention. It should be appreciated that each process and/or block, or a combination thereof, in the flow charts and/or block diagrams may be implemented via computer program commands. These computer program commands may be applied to a general-purpose computer, a special-purpose computer, an embedded processor or any other processor of programmable data processing equipment, so as to form a machine, thereby to obtain the means capable of effecting the functions specified in one or more processes in the flow charts and/or one or more blocks in the block diagrams in accordance with the commands executed by the computer or the processor of the other programmable data processing equipment.

These computer program commands may also be stored in a computer-readable memory capable of guiding the computer or the other programmable data processing equipment to work in a special manner, so as to form a product including a command device capable of effecting the functions specified in one or more processes in the flow charts and/or one or more blocks in the block diagrams.

These computer program commands may also be loaded onto a computer or the other programmable data processing equipment, so as to perform a series of operations thereon and generate the processing implemented by the computer, thereby to provide the steps capable of effecting the functions specified in one or more processes in the flow charts and/or one or more blocks in the block diagrams in accordance with the commands.

Although the preferred embodiments are described above, a person skilled in the art may make modifications and variations to these embodiments in accordance with the basic concept of the present invention. So, the appended claims are intended to include the preferred embodiments and all of the modifications and variations that fall within the scope of the present invention.

Obviously, a person skilled in the art may make modifications and variations if without departing from the spirit and scope of the present invention. The present invention is also intended to include the modifications and variations if they fall within the scope of the claims and the equivalents thereof.

1. A method for trackball-based press positioning, comprising:
receiving, by a processing module, deformation information from a multi-legged support for supporting a trackball and sensing pressure on the trackball;
comparing the received deformation information with deformation threshold information stored therein to determine a type of a pressing opreation on the trackball; and
when it is determined that the trackball is under pressure but not in contact with a pressure sensing module, recording a trajectory of the trackball by a positioning module, and performing corresponding opreations on displayed information in accordance with the trajectory.

2. The method according to claim 1, wherein determining that the trackball is under pressure but not in contact with the pressure sensing module includes:
comparing the received deformation information with first deformation threshold information which is determined in accordance with a dsitance between the trackball and the pressure sensing module when the trackball is under pressure but not in contact with the pressure sensing module and the deformation information of the multi-legged support that supports the trackball when the trackball is under pressure but not in contact with the pressure sensing module; and
determining that the trackball is under pressur ebut not in contact with the pressure sensing module when the deformation information is less than the first deformation threshold information.

3. The method according to claim 2, wherein determining that the trackball is under pressure but not in contact with the pressure sensing module further includes:
judging whether the pressure sensing module has received a signal indicating that it is pressed by the trackball when it is judged that the deformation information is greater than the first deformation threshold information; and
determining that the trackball is under pressure but not in contact with the pressure sensing module when the pressure sensing module does not receive the signal indicating that it is pressed by the trackball.

4. The method according to claim 3, further comprising:
when the pressure sensing module has received a pressing signal from the trackball, performing a point-and-click operation on the displayed information in accordance with the pressing signal.

5. The method according to claim 2, further comprising:
comparing the deformation information with second deformation threshold information stored therein when the deformation information is less than the first deformation threshold information; and
when the deformation information is less than the second deformation threshold information, determining that the trackball is being scrolled, recording a trajectory of the trackball by the positioning module, and performing a positioning operation on the displayed information in accordance with the trajectory.

6. A device for trackball-based press positioning, comprising:
a multi-legged support, a trackball, a processing module and a positioning module, wherein,
the multi-legged support, configured to support the trackball and sense pressure on the trackball of a mobile terminal, and transmit its own deformation information under the pressure to the processing module;
the trackball, configured to receive the pressure;
the processing module, configured to receive the deformation information from the multi-legged support, compare the received deformation information with deformation threshold information stored therein, determine a type of a pressing operation on the trackball, and notify the positioning module to determine the opreation information when it is determined that the trackball is under pressure but not in contact with a pressure sensing module; and
the positioning module configured to record a trajectory of the trackball and perform corresponding opreations on displayed information in accordance with the trajectory.

7. The device accordign to claim 6, wherein the processing module includes:
a storing unit, configured to store first deformation threshold information, which is determined in accordance with a distance between the trackball and the pressure sensing module when the trackball is under pressure but not in contact with the pressure sensing module and the deformation information of the multi-legged support that supports the trackball when the trackball is under pressure but not in contact with the pressure sensing module; and
a comparison determining unit, configured to determine that the trackball is under pressure but not in contact with the pressure sensing module when the deformation information is less than the first deformation threshold information.

8. The device according to claim 7, wherein
the processing module is further configured to judge whether the pressure sensing module has received a signal indicating that it is pressed by the trackball when the deformation information is greater than the first deformation threshold information, and determine that the trackball is under pressure but not in contact with the pressure sensing module when it does not receive the signal indicating that it is pressed by the trackball, and
the device further comprises a pressure sensing moduel configured to sense whether pressure is received from the trackball, generate a pressing signal when the pressure from the trackball is sensed, and transmit the pressing signal to the processing module.

9. The device according to claim 8, wherein the processing module is further configured to perform a point-and-click operation on the displayed information in accordance with the pressing signal when the pressure sensing module receives the pressing signal from the trackball.

10. The device according to claim 7, wherein the processing module is further configured to compare the deformation information with second deformation threshold information stored therein when the deformation information is less than the first deformation threshold information, determine that the trackball is being scrolled when the deformation information is less than the second deformation threshold information, record the trajectory of the trackball by the positioning module, and perform a positioning operation on the displayed information in accordance with the trajectory.

11. The device according to claim 6, wherein the multi-legged support includes elastic supports and supporting balls, and each of the elastic supports is provided with a sensor.

12. The device according to claim 6, wherein the multi-legged support comprises a three-legged support.
